(19) United States
(12) Patent Application Publication
(10) Pub. No.: US 2003/0038462 A1
(43) Pub. Date: Feb. 27, 2003

(54) Airbag gas generator as a vibration-damper mass

(76) Inventors: Markus Leibach, Schweighof (DE); Friedrich Back, Mullheim (DE); Markus Durre, Sulzberg (DE); Thilo Berg, Gimbsheim (DE)

Correspondence Address: KENYON & KENYON, ONE BROADWAY, NEW YORK, NY, 10004, US

(21) Appl. No.: 10/180,274

(22) Filed: Jun. 26, 2002

(30) Foreign Application Priority Data
Jun. 30, 2001 (DE) 101 31 830.8

(51) Int. Cl. B60R 21/16

(52) U.S. Cl. 280/731

(57) ABSTRACT

A gas generator for an airbag on the steering wheel of a motor vehicle, the gas generator being flexibly supported as a vibration-damper mass, by a gas-tight, annular, polymer spring element, on the airbag housing, and the part of the spring element that acts on the tank for the gas generator being provided with an inner ring, whose outer surface is joined to the spring element by vulcanization, and which is attached to the housing of the gas generator in a form-locked manner, wherein the form-locked connection of the ring (4, 24) to the tank (2) takes the form of a positioning groove (7, 17).

### BACKGROUND OF THE INVENTION

1. Field of the Invention

The invention relates to a gas generator for an airbag on the steering wheel of a motor vehicle, the gas generator being flexibly supported as a vibration-damper mass, by a gas-tight, annular, polymer spring element, on the airbag housing, and the part of the spring element that acts on the tank for the gas generator being provided with an inner ring, whose outer surface is joined to the spring element by vulcanization, and which is attached to the housing of the gas generator in a form-locked manner.

2. Description of Related Art

Vibration absorbers of the type described above damp the vibrations occurring in motor vehicles and thereby increase the ride comfort.

A gas generator used as a vibration absorber is known from DE 199 08 915 A1. In this context, the one edge of the gas-tight spring element is joined by a connecting sheet to the gas-generator tank, and the other edge of the gas-tight spring element is joined to a flange that allows a connection to the airbag housing. Vibration absorbers designed in such a manner have a number of advantages and are well suited for the intended area of application.

The prior application, DE 199 55 426, which likewise describes a gas generator designed as a vibration-damper mass, is also of relevance here. In this case, the gas generator is surrounded by a spacer pot or protective covering, in order to prevent the gas generator from damaging the airbag above it. In order to attach the spring element to the gas-generator housing, the spring element may be provided with an inner ring, which is joined to the housing of the gas generator in a form-locked manner. This construction allows a simple and reliable connection to be formed between the spring element and the gas-generator housing.

### SUMMARY OF THE INVENTION

It is an object of the invention to improve on the connection of the spring element to the gas-generator tank and the airbag housing, so as to provide a reliable connection between the gas-generator tank and the airbag housing, when the spring element is interposed. It is a further object of the invention to provide the simplest possible design by which the necessary connections may be easily manufactured. It is a further object of the invention to provide a connection which is as gas-tight as possible, so that it is not possible for the gases to be discharged in an uncontrolled manner upon activation of the gas generator.

These and other objects of the invention are achieved by designing the form-locked connection of the ring to the tank to be a positioning groove. Such a positioning groove, which grips the ring when the groove is formed on the gas-generator tank, or which may be present on the ring itself and enclose a corresponding edge, allows a connection to be produced, which meets the high safety requirements and is simple to manufacture. In addition, the positioning groove may be used for centering the gas-generator tank in an exact manner.

### BRIEF DESCRIPTION OF THE DRAWINGS

The present invention will be described in greater detail with reference to the following drawings wherein:

FIG. 1 shows a partial side view and partial sectional view of the embodiment of the gas-generator housing, in conjunction with the spring element.

FIG. 2 shows the enlarged detail Y from FIG. 1.

FIG. 3 shows a partial side view and partial sectional view of the gas-generator tank along with the spring element, the groove being formed in the ring.

FIG. 4 shows the enlarged detail X of FIG. 3.

### DETAILED DESCRIPTION OF THE INVENTION

A suitable option for such a groove connection is created, in that the positioning groove, into which the ring is inserted, is situated in a flange attached to the outer wall of the tank. On one side, the one edge of the ring is placed against the one circumferential groove wall, and on the other side, the ring is pressed against the groove wall by flanging partial segments of, or a terminal edge of the flange. When the terminal edge of the flange is flanged, a second lateral groove wall is formed, which may simultaneously take on the function of sealing. Consequently, there are two lateral groove walls, against which the edges of the ring rest so as to form a seal. In many cases, however, it is also sufficient for only partial segments of the flange to be flanged, in order to support the ring in the groove. These partial segments may be tabs cut out of the flange.

However, it is also possible to form the positioning groove in the ring, so that the flange present on the tank mates with this groove. In this case, a lateral groove wall of the ring is placed, on one side, against the edge of a connecting flange, and on the other side, the other lateral groove wall resting against the edge of the connecting flange is formed by flanging the groove-side edge of the ring. This specific embodiment is also easy to mount and provides a reliable seal against unintentional penetration of gas.

The edge of the spring element may be toroidal [bulbous], in order to attach the ring to the spring element. In this context, it is particularly favorable when the spring element forms an inner, circumferential groove in the region of the connection to the ring. This supports the spring action of the spring element and also produces an unbreakable transition between the actual spring element and the reinforcing protuberance for attaching the ring. Furthermore, this groove allows the flanging tool to act effectively, when the groove is formed in the ring itself.

In order to achieve a compact set-up of the ring and gas-generator tank, the inner surface of the ring is free of coatings of elastic material.

The part of the spring element facing the airbag housing is provided with a connecting flange in a manner known per se. This connecting flange may be joined to the spring element by vulcanization. The spring element itself is preferably designed as a sleeve-shaped frustum.

The new design has the advantage, that a live gas generator may be connected to the damper before or after being filled with propellant.

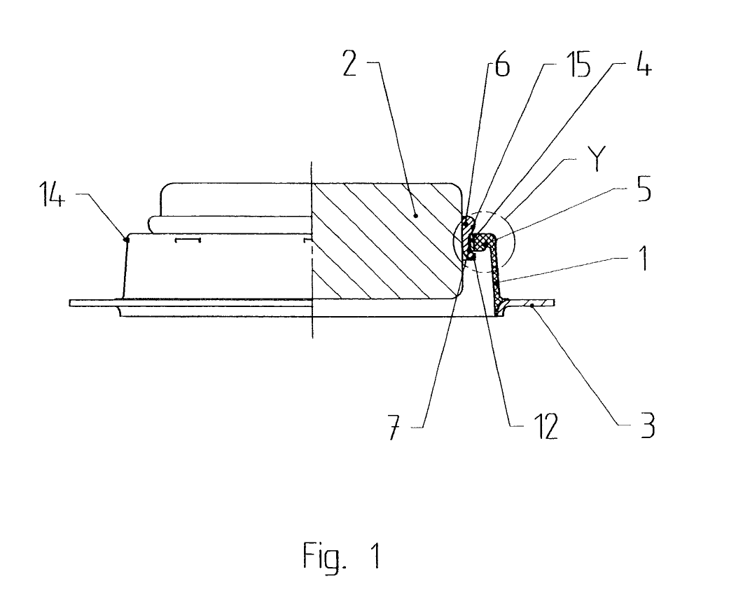

FIG. 1 shows only the parts essential to the present invention, namely spring element 1, gas-generator tank 2, connecting flange 3 for joining spring element 1 to an airbag housing, and the ring 4 on the inside of spring element 1. The airbag housing and gas generator are omitted. The gas generator is mounted in the interior of housing 2 in a known manner. Spring element 1 is connected to the airbag housing by flange 3. Spring element 1 is joined to flange 3 by vulcanization. A protuberance 5, on which ring 4 is vulcanized, is formed on the end of spring element 1 that faces gas-generator tank 2. Gas-generator tank 2 is provided with circumferential flange 6, which contains the groove 7 in which ring 4 is supported. The one lateral groove wall 10 is formed by a bulb 15 projecting from flange 6, and the other lateral groove wall 11 is formed by flanging lower edge 12 of flange 6, after ring 4 and tank 2 are brought into a suitable position relative to each other.

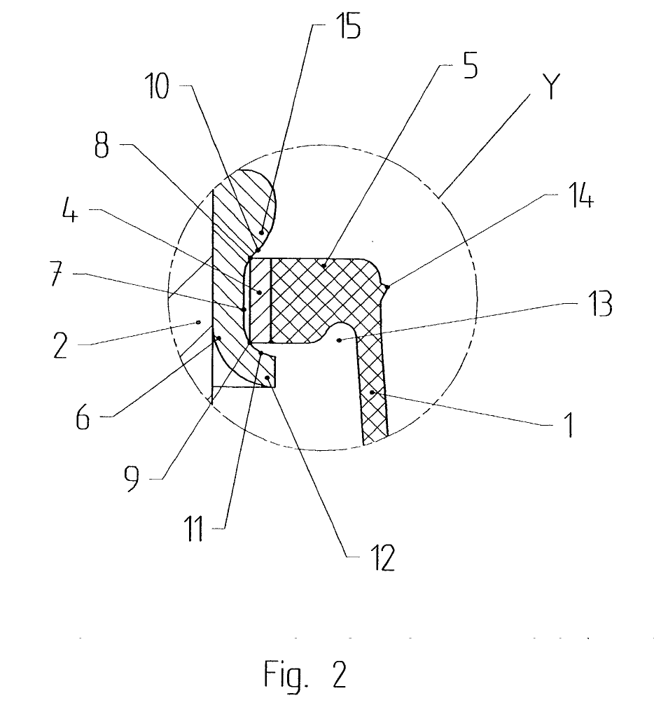

In FIG. 2, the detail Y of FIG. 1 is shown in an enlarged scale. Ring 4 is vulcanized to protuberance 5 of spring element 1 and is situated in groove 7. In this context, edges 8 and 9 of ring 4 abut against side walls 10 and 11 of groove 7 in a gas-tight manner. Lower edge 12 of flange 6 is flanged after ring 4, which includes spring element 1, is placed onto flange 6. The transition between the actual spring element 1 and protuberance 5 is provided with a circumferential groove 13. Formed on the outside of protuberance 5 is a plurality of concentric projections 14, which are used to dampen bumps, provided that spring element 1 comes to a stop on the protective jacket situated above it.

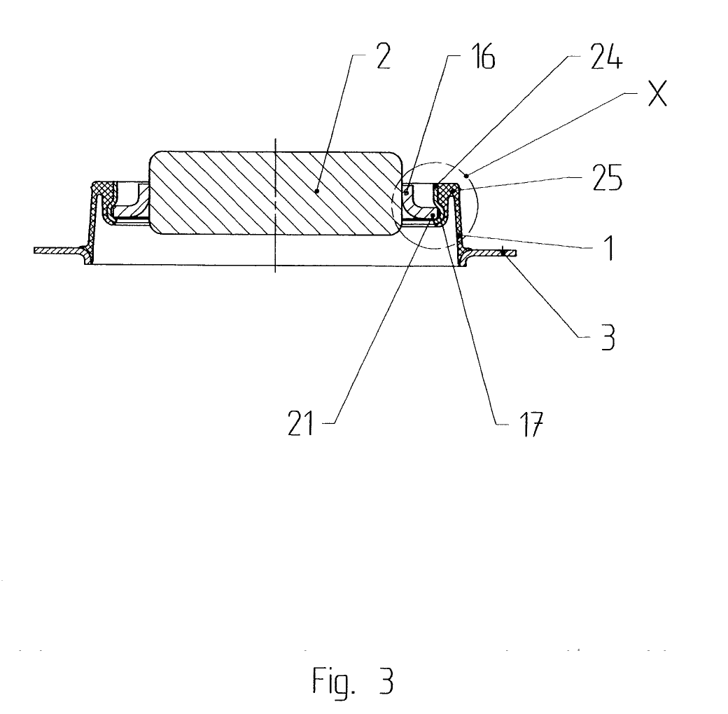

FIG. 3 shows a development, in which positioning groove 17 is formed in ring 24 itself. As far as spring element 1, connecting flange 3, and gas-generator tank 2 are concerned, they correspond to the specific embodiment according to FIG. 1. However, another refinement has retaining flange 16, which is attached to tank 2 and encircles tank 2 in the shape of a ring, and whose bottom end has an edge 21 that radially points in the outward direction. This edge 21 is situated in groove 17, which is formed by ring 24. Ring 24 is vulcanized to protuberance 25. In this context, ring 24 and protuberance 25 are initially formed in such a manner, that the tank 2 having flange 16 may be inserted into the spring element 1 having ring 24, and lower edge 39 of ring 24 is only subsequently flanged to form groove 17, which grips lower edge 21 of flange 16 in a form-locked manner.

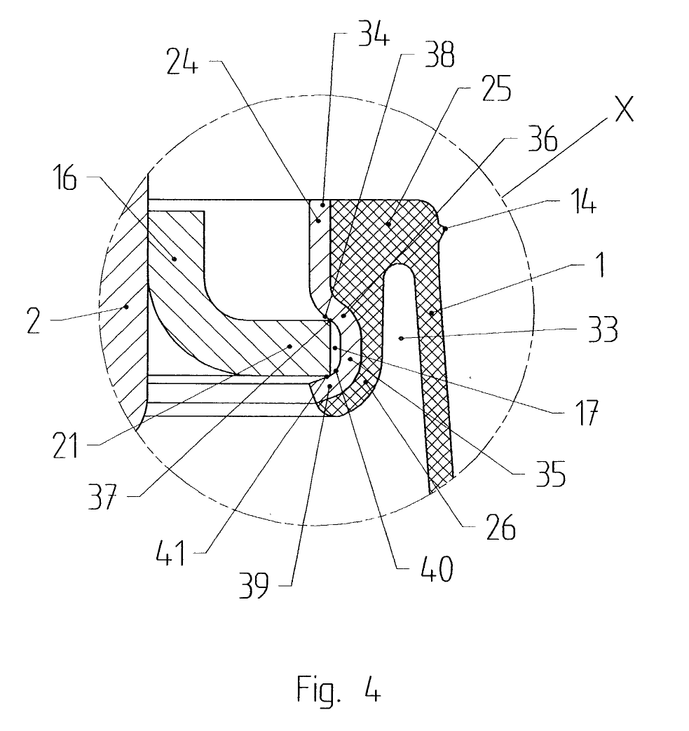

In FIG. 4, the detail X of FIG. 3 is shown in an enlarged scale. The top end of frustoconical spring element 1 has protuberance 25, to which ring 24 is vulcanized. Protuberance 25 is provided with a projection 26 that is pointed downwards, and circumferential groove 33 is present between this projection 26 and the actual spring element 1. Ring 24 is initially made of two cylindrical halves 34 and 35, which are interconnected by transverse shoulder 36. After tank 2 is inserted along with flange 16, into spring element 1, edge 37 of bent flange end 21 makes contact with lateral groove wall 38 of ring 24. Bottom end 39 of ring 24 is then flanged to form second lateral groove wall 40, at which ring 24 makes contact with lower edge 41 of flange 16.

What is claimed is:

1. A gas generator for an airbag on the steering wheel of a motor vehicle, the gas generator being flexibly supported as a vibration-damper mass, by a gas-tight, annular, polymer spring element, on the airbag housing, and the part of the spring element that acts on the tank for the gas generator being provided with an inner ring, whose outer surface is joined to the spring element by vulcanization, and which is joined to the housing of the gas generator in a form-locked manner, wherein the form-locked connection of the ring (4, 24) to the tank (2) takes the form of a positioning groove (7, 17).

2. The gas generator according to claim 1, wherein the positioning groove (7) is formed in a flange (6) on an outer wall of the tank (2), and on one side, the ring (4) abuts against a circumferential, lateral groove wall (10), and on the other side, the ring is pressed against the lateral groove wall (10) by flanging partial segments of, or a terminal edge (12) of the flange (6).

3. The gas generator according to claim 2, wherein the partial segments are tabs cut out of the flange (6).

4. The gas generator according to claim 1, wherein the positioning groove (17) is formed in the ring (24) itself, and on one side, a lateral groove wall (38) of the ring (24) rests against an edge (37) of a connecting flange (16) that encircles the tank (2), and on the other side, the other lateral groove wall (40) resting against the edge (41) of the connecting flange (16) is formed by flanging the groove-side end (39) of the ring.

5. The gas generator according to claim 1, wherein the spring element (1) forms an inner circumferential groove (13, 33) in the region of the connection to the ring (4, 24).

6. The gas generator according to claim 2, wherein the spring element (1) forms an inner circumferential groove (13, 33) in the region of the connection to the ring (4, 24).

7. The gas generator according to claim 3, wherein the spring element (1) forms an inner circumferential groove (13, 33) in the region of the connection to the ring (4, 24).

8. The gas generator according to claim 4, wherein the spring element (1) forms an inner circumferential groove (13, 33) in the region of the connection to the ring (4, 24).

9. The gas generator according to claim 1, wherein the inner surface of the ring (4, 24) is free of coatings of elastic material.

10. The gas generator according to claim 2, wherein the inner surface of the ring (4, 24) is free of coatings of elastic material.

11. The gas generator according to claim 3, wherein the inner surface of the ring (4, 24) is free of coatings of elastic material.

12. The gas generator according to claim 4, wherein the inner surface of the ring (4, 24) is free of coatings of elastic material.

13. The gas generator according to claim 5, wherein the inner surface of the ring (4, 24) is free of coatings of elastic material.

14. The gas generator according to claim 1, wherein a part of the spring element (1) facing the airbag housing has a connecting flange (3).

15. The gas generator according to claim 2, wherein a part of the spring element (1) facing the airbag housing has a connecting flange (3).

16. The gas generator according to claim 14, wherein the spring element (1) is joined to the connecting flange (3) by vulcanization.

17. The gas generator according to claim 1, wherein the ring (4, 24) has an essentially cylindrical shape and is aligned parallelly to the tank wall.

18. The gas generator according to claim 2, wherein the ring (4, 24) has an essentially cylindrical shape and is aligned parallelly to the tank wall.

19. The gas generator according to claim 1, wherein the spring element (1) takes the form of a sleeve-shaped frustum.

20. The gas generator according to claim 2, wherein the spring element (1) takes the form of a sleeve-shaped frustum.
